(19) United States
(12) Patent Application Publication
(10) Pub. No.: US 2009/0176133 A1
(43) Pub. Date: Jul. 9, 2009

(54) FUEL CELL CONTROL SYSTEM AND CONTROL METHOD THEREOF

(75) Inventors: Fu-Cheng Wang, Taipei (TW); Hsuan-Tsung Chen, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: NATIONAL TAIWAN UNIVERSITY, Taipei (TW)

(21) Appl. No.: 12/275,657

(22) Filed: Nov. 21, 2008

(30) Foreign Application Priority Data
Jan. 4, 2008 (TW) 097100282

(51) Int. Cl. H01M 8/04

(52) U.S. Cl. 429/13; 429/23

(57) ABSTRACT

A fuel cell control system and a control method thereof are provided. The fuel cell control system includes an air supply module, a fuel supply module having a fuel supply end, a fuel cell set having an electrical output end, an measuring unit and a control module having an arithmetic logic unit. A set of control algorithms is employed to effectively adjust the electrical output in order to identify the transfer function and to perform controller design. When the electrical output of the fuel cell is different from the default electrical output, the controller then regulates the fuel supply and the air supply to provide a stable fuel cell electrical output and to reduce fuel consumption.

### BACKGROUND OF THE INVENTION

1. Field of the Invention

The present invention generally relates to a control technique, and more particularly, to a fuel cell control system and a control method thereof.

2. Description of Related Art

A fuel cell is a device that directly transforms chemical energy to electrical energy. Electrical power can be supplied continuously by providing the fuel cell with fuel, wherein the fuel can be hydrogen, methanol, ethanol, natural gas or other hydrocarbon, which reacts with oxygen to produce electricity with byproducts of heat and water.

A fuel cell consists of three key elements, namely the anode, cathode and membrane located between the anode and the cathode. The three elements are combined into a membrane electrode assembly (MEA) which is further mounted with bipolar plates to form a single cell.

For a proton exchange membrane fuel cell (PEMFC), the hydrogen and oxygen are supplied to the anode and cathode of the fuel cell, respectively. At the anode, the hydrogen is ionized into positive hydrogen ions and electrons through catalyst. The electrons, which travel along an external circuit and the load from the anode to the cathode, combine with the positive hydrogen ions, which pass through the polymer electrolyte membrane, and the oxygen which is supplied at the cathode to form water. This process can be represented as follows:

| | |
|---|---|
| Anode: | 2H₂ → 4H⁺ + 4e⁻ |
| Cathode: | 4H⁺ + O₂ + 4e⁻ → 2H₂O |
| Total reaction: | 2H₂ + O₂ → 2H₂O |

Since a fuel cell is an electrochemical reaction system, the efficiency and stability of the fuel cell are influenced by operating conditions such as temperature of the reaction system, the fuel/oxidant ratio, and the catalyst. Therefore, trial and error methods are usually applied to control the system operating conditions and the fuel ratio, in order to improve the stability and efficiency of the fuel cell system.

Basically, the trial and error method substantially consists of the following steps: monitoring and analyzing the operating conditions and the electrical output; finding system errors and adjusting the errors based on the analyzed results; and further adjusting the operating conditions and fuel ratio of the fuel cell system so as to improve the system stability and efficiency.

US Patent Application Publication No. 2004/0137294 discloses a technique for controlling fuel concentration at the anode of a fuel cell system. The technique uses an H-Infinity controller in a feedback loop to control the fuel concentration at the anode. The control algorithm of the H-infinity control loop is disclosed in detail. However, the publication only discloses the control algorithm of the H-infinity control loop for the fuel concentration at the anode of a fuel system and does not disclose any techniques for controlling other reaction conditions. As a fuel cell system is an electrochemical reaction system that is affected by a variety of reaction conditions. If only one of the reaction conditions is controlled, the final reaction of the electrochemical reaction system cannot be effectively derived. As a result, the electrical output of the fuel cell system cannot be effectively regulated.

US Patent Application Publication No. 2006/0125441 discloses a technique for nonlinear control of the proton exchange membrane fuel cells. The publication discloses a nonlinear control loop for stabilizing the reaction temperature of the proton exchange membrane fuel cells. The nonlinear control algorithm is disclosed in the publication in detail. However, the publication only discloses the control algorithm of the nonlinear control loop for stabilizing the reaction temperature of the proton exchange membrane fuel cells and does not disclose any techniques for controlling other reaction conditions. As mentioned above, a fuel cell system is an electrochemical reaction system that is affected by a variety of reaction conditions. If only the reaction temperature of the proton exchange membrane fuel cells is controlled, the final reaction of the electrochemical reaction system cannot be effectively obtained. As a result, the electrical output of the fuel cell cannot be effectively adjusted.

Since steady electrical output of the fuel cell is of importance for fuel cell applications, it has become a highly urgent issue for designers in the fuel cell industry to provide a control algorithm to efficiently adjust the electrical output of the fuel cell, in order to stabilize the electrical output and reduce the fuel consumption of fuel cell systems.

### SUMMARY OF THE INVENTION

In view of the above technical disadvantages, the present invention provides a fuel cell control system and a control method thereof so as to stabilize the electrical output and reduce the fuel consumption of a system.

The fuel cell control system of the present invention includes an air supply module, a fuel supply module having a fuel supply end, a fuel cell set having an electrical output end, a measuring unit, and a control module having an arithmetic logic unit. The fuel cell set has the electrical output end, wherein upon receiving the fuel from the fuel supply module and the air from the air supply module, the fuel reacts with the air to generate the electrical output, which is then presented at the electrical output end. The measuring unit measures the electrical output at the electrical output end. The control module sets the default electrical output and receives the actual electrical output from the measuring unit, wherein the arithmetic logic unit is used to identify the transfer function. The transfer function can then be used as a basis for the design of the controller that calculates and generates a fuel control signal and an air control signal.

The fuel cell control method includes the following steps: (1) setting a default electrical output by a control module; (2) sending a fuel supply test signal and an air supply test signal to a fuel supply module and an air supply module respectively via the control module such that the fuel supply module and the air supply module respectively supply the fuel and the air to the fuel cell set according to the test signals; (3) generating the electrical output by the fuel cell set where the fuel reacts with the air so as to output the electrical output at the electrical output end. In addition, the electrical output of the fuel cell is measured using the measuring unit to obtain a test electrical output which is further sent to the arithmetic logic unit directly; (4) using the arithmetic logic unit to compare the test electrical output, the default electrical output, the fuel supply control signal and the air supply control signal so as to identify the transfer function and determine the control rules; (5) using the control module to send the fuel supply control signal to the fuel supply module, and to send the air supply control signal to the air supply module, to supply the fuel and the air to the fuel cell set accordingly; (6) using the fuel cell set to generate the electrical output, and thus presenting the electrical output at the electrical output end, as well as measuring the electrical output of the fuel cell with the measuring unit so as to obtain an electrical output to be further sent to the arithmetic logic unit; and (7) comparing the obtained electrical output with the default electrical output via the arithmetic logic unit, which further performs the arithmetic operation according to the control rules to dynamically adjust the fuel supply control signal and the air supply control signal for stabilizing the electrical output and reducing the fuel consumption.

In contrast with the prior art, the fuel cell system and the control method of the present invention employ a set of control algorithms that effectively regulate the electrical output of the fuel cell. The control algorithms compare the test electrical output, the default electrical output, the fuel supply control signal and the air supply control signal, so as to identify the transfer function of the fuel cell system. The transfer function then serves as a basis for controller design.

Further, the fuel cell system dynamically monitors the electrical output of the fuel cell. If there exists a difference between the electrical output and the default electrical output, the arithmetic logic unit compares the difference, and then performs the arithmetic operation to regulate the fuel supply control signal and the air supply control signal, thereby allowing the fuel cell system to dynamically modify the fuel and air supplies and accordingly to stabilize the electrical output of the fuel cell as well as to reduce the fuel consumption significantly.

### BRIEF DESCRIPTION OF DRAWINGS

FIG. 1 is a functional block diagram of a fuel cell control system in accordance with the present invention;

FIG. 2 is a flow chart of a fuel cell control method in accordance with the present invention;

FIG. 3 illustrates a closed-loop fuel cell control system in accordance with the present invention;

FIG. 4 illustrates the design concept of a controller of a fuel cell control system in accordance with the present invention;

FIGS. 5a to 5c are diagrams showing the voltage control result, a fuel supply monitor graph and an air supply monitor graph according to a first embodiment of the present invention; and

FIGS. 6a to 6c are diagrams illustrating the voltage control result, a fuel supply monitor graph and an air supply monitor graph according to a second embodiment of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

The following embodiments further illustrate the points of the present invention in detail. However, the scope of the invention is not limited to any points.

### First Embodiment

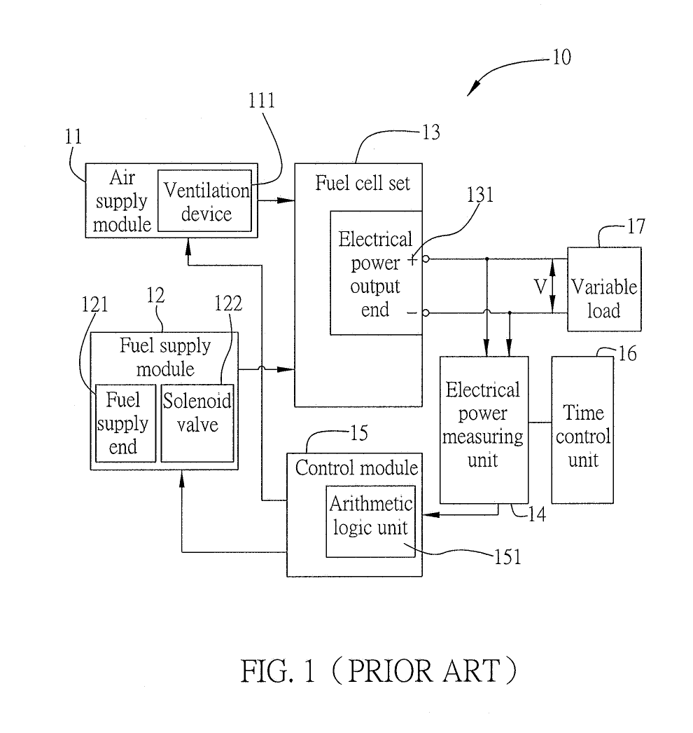

FIG. 1 is a functional block diagram of a fuel cell control system 10 according to the present invention. As shown in FIG. 1, the fuel cell control system 10 comprises an air supply module 11 having an air-feeding device 111, a fuel supply module 12 having a fuel supply end 121 and a solenoid valve 122, a fuel cell set 13 having an electrical output end 131, a measuring unit 14, and a control module 15 having an arithmetic logic unit 151. The air supply module 11 controls the air-feeding device 111, which is used for regulating the air supply volume. The fuel supply module 12 controls the solenoid valve 122 to regulate the fuel supply amount. The fuel cell set 13 receives fuel from the fuel supply module 12 and air from the air supply module 11, thereby generating the electrical output through the reaction of the fuel and the air. The electrical output generated is further presented at the electrical output end 131. The measuring unit 14 measures the electrical output at the electrical output end 131. The control module 15 sets a default electrical output and receives the actual electrical power output measured by the measuring unit 14. The arithmetic logic unit 151 identifies a transfer function of the fuel cell control system 10. The transfer function serves as a basis for the design of a controller that generates a fuel control signal as well as an air control signal.

The fuel cell control system 10 of the present invention further includes a time control unit 16 which is used to determine the time interval for a loop operation of a system. In addition, in the end of the time interval, the measuring unit 14 is prompted to measure the electrical output at the electrical output end 131. Further, a system control described as follows is performed according to the measured electrical power output.

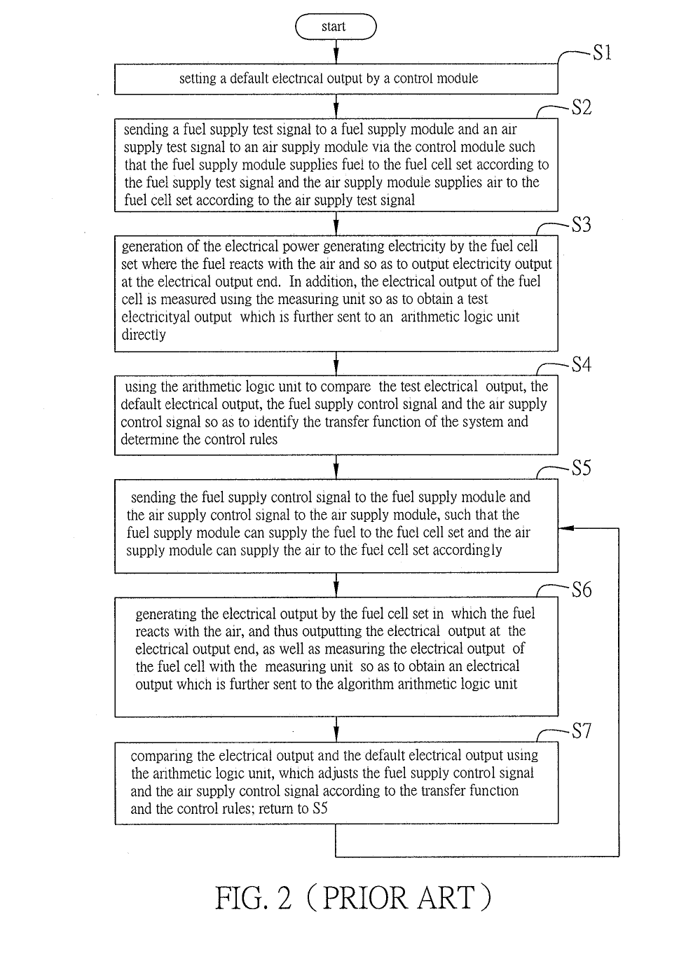

Referring to FIG. 2, a flow chart of a fuel cell control method according to the present invention is shown. The fuel cell control method comprises the following steps. In step S1, the control module 15 sets a default electrical output. In step S2, the control module 15 sends a fuel supply test signal to the fuel supply module 12 and an air supply test signal to the air supply module 11. The fuel supply module 12 supplies fuel to the fuel cell set 13 according to the fuel supply test signal, and the air supply module 11 supplies air to the fuel cell set 13 according to the air supply test signal. In step S3, the fuel cell set 13 generates a test electrical output through the reaction of the fuel and the air, and outputs the test electrical at the electrical output end 13 1, and the measuring unit 14 measures the test electrical output to obtain a measured test electrical output, and sends the measured test electrical output to the arithmetic logic unit 151. In step S4, the measured test electrical output, the default electrical output, a fuel supply control signal and an air supply control signal are compared to identify the transfer function of the fuel cell system 10, the transfer function serving as a basis for the controller design. In step S5, the control module 15 sends the fuel supply control signal to the fuel supply module 12 and sends the air supply control signal to the air supply module 11. The fuel supply module 12 supplies the fuel to the fuel cell set 13, and the air supply module 11 supplies the air to the fuel cell set 13 to the fuel cell set 13. In step S6, the fuel cell module 13 generates electrical output through the reaction of the fuel and the air, and outputs the generated electrical output at the electrical output end 13 1, and the measuring unit 14 measures the generated electrical output of the fuel cell set 13 to obtain an electrical output, and sends the obtained electric output to the arithmetic logic unit 151. In step S7, the arithmetic logic unit 151 compares the obtained electrical output with the default electrical output, and the controller performs the arithmetic operation to adjust the fuel supply control signal and the air supply control signal. The control method returns to step S5 after the fuel supply control signal and the air supply control are adjusted.

Therein, the transfer function is identified by supplying the air supply test signal and the fuel supply test signal around a selected system operating point so as to regulate the air supply volume and the fuel supply amount, respectively. The output voltage of the test system is recorded, such that multivariable system identification techniques can be used to identify the system transfer function matrices. Since the fuel cell system is non-linear and time-varying, multiple system transfer functions may be identified.

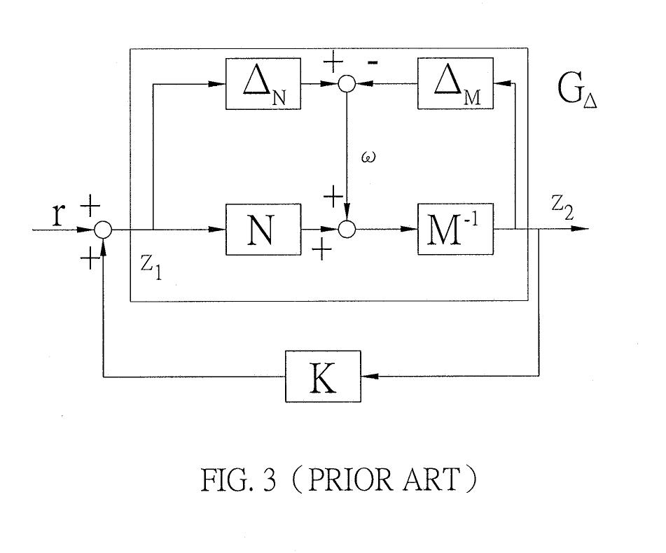

Subsequently, the most appropriate system transfer function is determined in accordance with the gap metric. The system is called a nominal plant. Selection of the nominal plant is determined according to the gap between the nominal plant and the perturbed plant. FIG. 3 illustrates a closed-loop fuel cell control system according to the present invention, wherein r denotes an input reference value, G₀=M⁻¹N refers to the defined nominal plant, and K represents a controller designed based on the nominal plant. As shown in FIG. 3, based on normalized left coprime factorization, the nominal plant is defined as G₀=M¹N, and the perturbed plant is given by G_{Δ}=(M+Δ_{M})¹(N+Δ_{N}). The gap value between the nominal plant and the perturbed plant is ∥[Δ_{M}, Δ_{N}]∥_{∞}. The perturbation between transfer functions is compared according to the following equation so as to find the most appropriate transfer function to describe the nominal plant.

$${min}_{{G}_{0}} {max}_{{G}_{i}} δ ( {G}_{0} , {G}_{i} ) = ɛ$$

wherein G₀ is the nominal plant, Gᵢ refers to the perturbed plant, and ε gives the maximum perturbation of the plant.

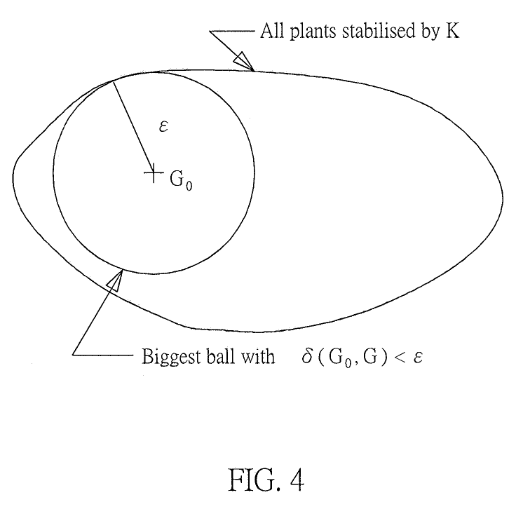

After the transfer function is determined, a control rule stated below is designed according to the transfer function of the nominal plant.

$$b ( {G}_{0} , K ) = {‖ [ \begin{matrix}K \\ I\end{matrix} ] {( I - {G}_{0} K )}^{- 1} [ I {G}_{0} ] ‖}_{∞}^{- 1} \geq ɛ ,$$

in which K denoting a designed controller, b(G₀,K) referring to the stability bound of the controller designed according to the nominal plant, ∥T∥_{∞} representing the infinity norm of system T, ε giving the maximum perturbation of the plant. The design concept of the present invention is shown in FIG. 4. The design objective is to make the stability bound greater than or equal to the maximum perturbation of the plant. While the control signal is generated by the above selection rule and algorithm rule, the controlled system is adjusted during perturbation, thereby keeping the system stable.

With the system and the controller design as disclosed above, the following description is a control system of a proton exchange membrane fuel cell (PEMFC) which is used as an example. The power rating of the PEMFC is 100 W, the voltage rating is 10V, the current rating is 10 A, the effective area of the proton exchange membrane is 50 cm² (5 cm×10 cm), the anode gas is hydrogen, the cathode gas is air, and the time interval for the loop operation of a system is 1/100 second. It is to be noted that after reading the disclosure, those skilled in the art will understand that the time interval for the loop operation of a system can be adjusted accordingly in practice.

Firstly, in step S1 the control module 15 set a default electrical output. In step S2, the control module 15 sends a fuel supply test signal to the fuel supply module 12 and an air supply test signal to the air supply module 11, the fuel supply module 12 supplies the fuel to the fuel cell set 13 according to the fuel supply test signal, and the air supply module 11 supplies the air to the fuel cell set 13 according to the air supply test signal. In step S3, the fuel cell set 13 generates the test electrical output through the reaction of the fuel with the air, and outputs the test electrical output at the electrical output end 131, and the measuring unit 14 measures the test electrical output to obtain a measured test electrical output, and sends the measured test electrical output to the arithmetic logic unit 151. The arithmetic logic unit 151 identifies several sets of transfer functions for the PEMFC system by using system identification techniques. The transfer functions are shown in Table 1.

TABLE 1

| | 2A |
|---|---|
| 1 | ${G}_{11} = [ \begin{matrix}\frac{0.00202 z - 0.001598}{{z}^{2} - 1.954 z + 0.9555} & \frac{0.000505 z - 0.0003996}{{z}^{2} - 1.954 z + 0.9555}\end{matrix} ]$ |
| 2 | ${G}_{12} = [ \begin{matrix}\frac{0.00156 z - 0.001158}{{z}^{2} - 1.976 z + 0.9771} & \frac{0.0003901 z - 0.0002896}{{z}^{2} - 1.976 z + 0.9771}\end{matrix} ]$ |
| 3 | ${G}_{13} = [ \begin{matrix}\frac{0.0006934 z - 0.000162}{{z}^{2} - 1.942 z + 0.9457} & \frac{0.0001733 z - 0.0000405}{{z}^{2} - 1.942 z + 0.9457}\end{matrix} ]$ |
| | 3A |
| 1 | ${G}_{21} = [ \begin{matrix}\frac{0.001935 z - 0.00153}{{z}^{2} - 1.971 z + 0.973} & \frac{0.0004837 z - 0.0003824}{{z}^{2} - 1.971 z + 0.973}\end{matrix} ]$ |
| 2 | ${G}_{22} = [ \begin{matrix}\frac{0.001919 z - 0.001483}{{z}^{2} - 1.974 z + 0.9753} & \frac{0.0004798 z - 0.0003708}{{z}^{2} - 1.974 z + 0.9753}\end{matrix} ]$ |
| 3 | ${G}_{23} = [ \begin{matrix}\frac{0.00154 z - 0.000985}{{z}^{2} - 1.948 z + 0.95} & \frac{0.0003851 z - 0.0002462}{{z}^{2} - 1.948 z + 0.95}\end{matrix} ]$ |
| | 4A |
| 1 | ${G}_{31} = [ \begin{matrix}\frac{0.001603 z - 0.001052}{{z}^{2} - 1.934 z + 0.9373} & \frac{0.0004 z - 0.0002629}{{z}^{2} - 1.934 z + 0.9373}\end{matrix} ]$ |
| 2 | ${G}_{32} = [ \begin{matrix}\frac{0.001774 z - 0.001231}{{z}^{2} - 1.932 z + 0.9354} & \frac{0.0004435 z - 0.0003077}{{z}^{2} - 1.932 z + 0.9354}\end{matrix} ]$ |
| 3 | ${G}_{33} = [ \begin{matrix}\frac{0.001483 z - 0.0009106}{{z}^{2} - 1.918 z + 0.9208} & \frac{0.0003707 z - 0.0002277}{{z}^{2} - 1.918 z + 0.9208}\end{matrix} ]$ |

The arithmetic logic unit 151 further uses the above-described transfer function selection technique to define a nominal plant as G₀=M⁻¹N using normalized left coprime factorization. The perturbed plant is given by G_{Δ}=(M+Δ_{M})⁻¹(N+Δ_{N}), and the gap between the defined nominal and perturbed plant is described by ∥[Δ_{M},Δ_{N}]∥_{∞}. Further, according to the following equation:

$${min}_{{G}_{0}} {max}_{{G}_{i}} δ ( {G}_{0} , {G}_{i} ) ,$$

the perturbation between the transfer functions is compared to derive the most appropriate transfer function to represent the nominal system. The perturbation values of the transfer functions of the PEMFC are shown in Table 2.

TABLE 2

| | G₁₁ | G₁₂ | G₁₃ | G₂₁ | G₂₂ | G₂₃ | G₃₁ | G₃₂ | G₃₃ |
|---|---|---|---|---|---|---|---|---|---|
| G₁₁ | 0 | 0.2127 | 0.1346 | 0.1278 | 0.3054 | 0.0751 | 0.078 | 0.0966 | 0.0956 |
| G₁₂ | 0.2127 | 0 | 0.3395 | 0.2098 | 0.2137 | 0.1649 | 0.2858 | 0.3034 | 0.3044 |
| G₁₃ | 0.1346 | 0.3395 | 0 | 0.2068 | 0.4254 | 0.1932 | 0.0585 | 0.039 | 0.0488 |
| G₂₁ | 0.1278 | 0.2098 | 0.2068 | 0 | 0.3522 | 0.1327 | 0.161 | 0.1785 | 0.1922 |
| G₂₂ | 0.3054 | 0.2137 | 0.4254 | 0.3522 | 0 | 0.2449 | 0.3736 | 0.3902 | 0.3844 |
| G₂₃ | 0.0751 | 0.1649 | 0.1932 | 0.1327 | 0.2449 | 0 | 0.1366 | 0.1551 | 0.1522 |
| G₃₁ | 0.078 | 0.2858 | 0.0585 | 0.161 | 0.3736 | 0.1366 | 0 | 0.0195 | 0.0341 |
| G₃₂ | 0.0966 | 0.3034 | 0.039 | 0.1785 | 0.3902 | 0.1551 | 0.0195 | 0 | 0.0263 |
| G₃₃ | 0.0956 | 0.3044 | 0.0488 | 0.1922 | 0.3844 | 0.1522 | 0.0341 | 0.0263 | 0 |
| Max | 0.3054 | 0.3395 | 0.4254 | 0.3522 | 0.4254 | 0.2449 | 0.3736 | 0.3902 | 0.3844 |

The most appropriate transfer function is selected by analyzing Table 2. In the present embodiment, the selected transfer function is G₂₃,

$${G}_{23} ( z ) = [ \frac{0.00154 z - 0.000985}{{z}^{2} - 1.948 z + 0.95} \frac{0.0003851 z - 0.0002462}{{z}^{2} - 1.948 z + 0.95} ]$$

The maximum perturbation of the plant is

$${min}_{{G}_{0}} {max}_{{G}_{i}} δ ( {G}_{0} , {G}_{i} ) = 0.2449$$

The weighting function is chosen as

$${W}_{1} ( z ) = [ \begin{matrix}\frac{z - 0.99}{z - 1} & 0 \\ 0 & \frac{0.006}{z - 1}\end{matrix} ]$$

According to the above-described conditions, a robust controller designed corresponding to G₂₃W₁ is,

$${K}_{23} ( z ) = [ \begin{matrix}\frac{- 0.8446 {z}^{2} + 1.647 z - 0.804}{{z}^{2} - 1.941 z + 0.9422} \\ \frac{- 0.08869 {z}^{2} + 0.1728 z - 0.08427}{{z}^{2} - 1.941 z + 0.9422}\end{matrix} ]$$

The corresponding stability bound is b(G₂₃W₁, K₂₃)=0.7622, which is greater than the perturbation limit ε=0.2449.

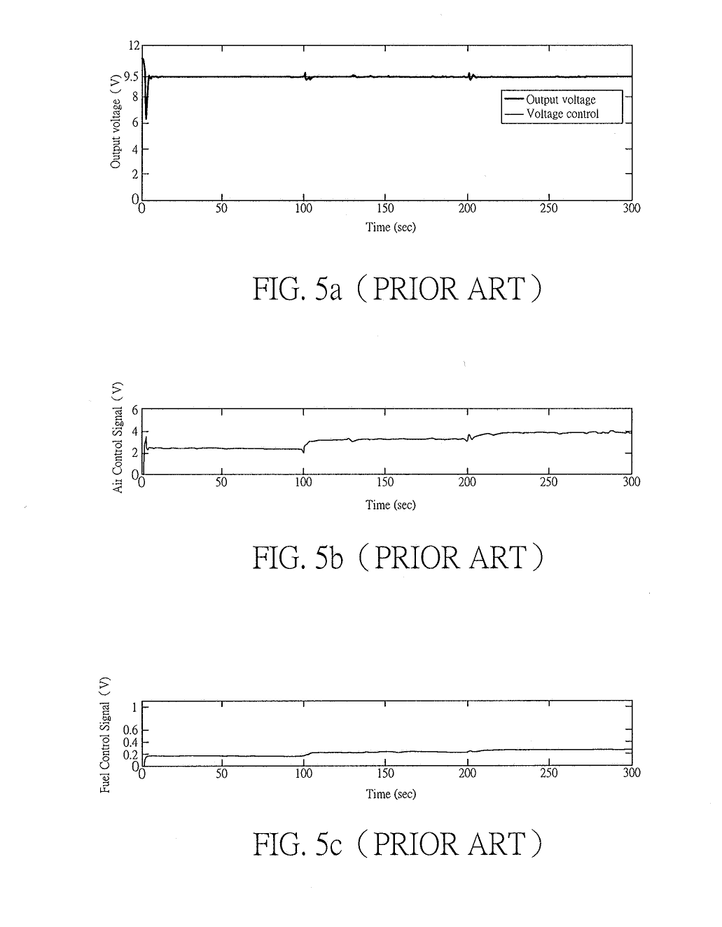

Referring to FIG. 5a and Table 3,

TABLE 3

| | 2 A→3 A→4 A | | |
|---|---|---|---|
| | 20 s→100 s | 100 s→200 s | 200 s→300 s |
| RMS error | 0.0142 | 0.0361 | 0.0371 |
| Average air pump | 2.3692 | 3.1905 | 3.7959 |
| voltage (V) | | | |
| Average hydrogen | 19.75% | 25.38% | 29.63% |
| duty ratio | | | |

The present embodiment connects an external variable load 17 to the electrical output end 131. In addition, the current through the external variable load 17 varying within the specified range (2A→3A→4A) shows that the fuel cell control system of the present invention stabilizes the fuel cell voltage at 9.5V. In other words, the fuel cell control system of the present invention achieves the objective of stabilizing the output voltage. Table 3 shows a data collection corresponding to the control signals of the present embodiment. It shows that the duty ratio of the hydrogen is reduced from 100% to less than 30%. Based on the above statistics, the fuel cell control system according to the present invention not only stabilizes the output voltage even when the current load fluctuates through the external variable load 17, but also effectively reduces the fuel consumption.

### Second Embodiment

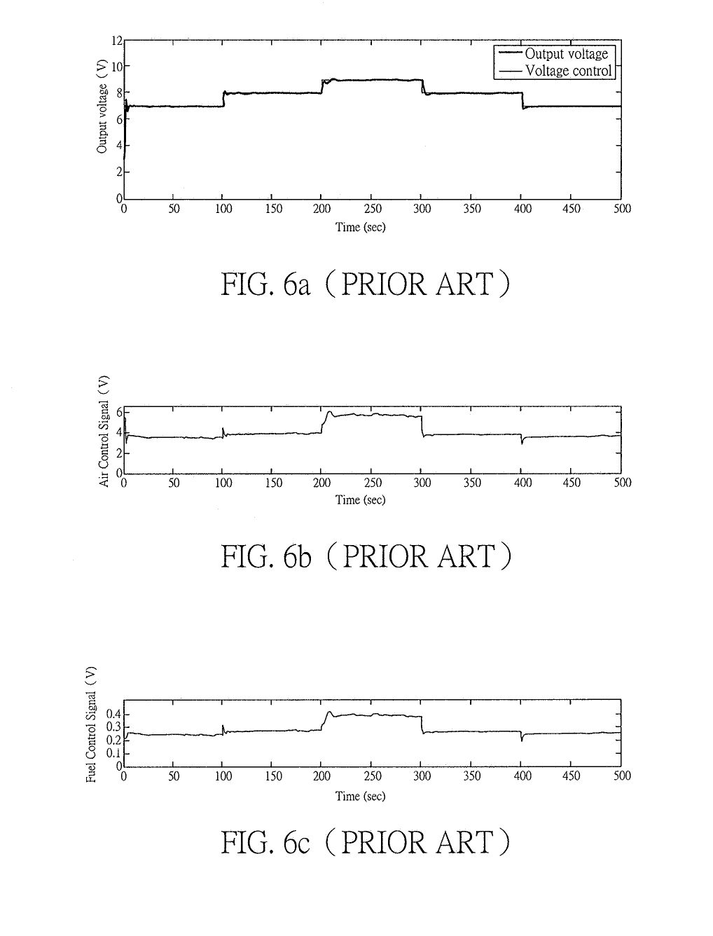

Further referring to FIG. 6 and Table 4:

TABLE 4

| | 7 v | 8 v | 9 v | 8 v | 7 v |
|---|---|---|---|---|---|
| | 20 s→100 s | 100 s→200 s | 200 s→300 s | 300 s→400 s | 400 s→500 s |
| RMS error | 0.0227 | 0.0507 | 0.0772 | 0.1024 | 0.0641 |
| Average air pump | 3.4375 | 3.8177 | 5.6203 | 3.7858 | 3.6014 |
| voltage (V) | | | | | |
| Average hydrogen | 29.63% | 29.70% | 39.30% | 29.78% | 29.65% |
| duty ratio | | | | | |

The difference of the present embodiment from the first embodiment is that the fuel cell control system 10 of the present invention is connected to an electronic element of a variable load 17 such as a DC motor. FIG. 6a shows that the fuel cell control system of the present invention effectively stabilizes the output voltage. Table 4 shows the data collection corresponding to the control signals according to the present embodiment. In addition, it is shown in FIG. 6c that the duty ratio of the hydrogen is reduced from 100% to less than 40%. Thus, it is concluded that the fuel cell control system of the present invention, when connected to the electronic component of the variable load 17, can effectively maintain the stability of the output voltage as well as reduce the fuel consumption.

Based on the above embodiments and their contents, the system and method for controlling the fuel cell of the present invention employ a set of control algorithms that effectively regulate the electrical power output of the fuel cell. The set of control algorithms compare the relationships between the test electrical power output value, the default electrical power output value, the fuel supply control signal and the air supply control signal, so as to identify the system transfer function. Further, the control system dynamically monitors the electrical power output value of the fuel cell. If there exists a difference between the electrical power output value and the default electrical power output value, the arithmetic logic unit uses the transfer function to generate the fuel supply control signal and the air supply control signal, thereby allowing dynamic modification of the fuel and air supplies to sufficiently stabilize the output electrical power of the fuel cell and to reduce the fuel consumption significantly.

While the invention has been particularly shown and described with reference to preferred embodiments for purposes of illustration, it will be understood that variations and modifications can be effected thereto by those skilled in the art without departing from the spirit and scope of the invention as defined by the appended claims.

What is claimed is:

1. A fuel cell control system, comprising:
an air supply module for supplying air;
a fuel supply module for supplying fuel;
a fuel cell set for receiving the air from the air supply module and the fuel from the fuel supply module, the fuel cell set having an electrical output end for transmitting an electrical output generated from a reaction of the fuel with the air;
a measuring unit for measuring the electrical output at the electrical output end; and
a control module for setting a default electrical output and receiving the measured electrical output from the measuring unit, the control module having an arithmetic logic unit for identifying a transfer function of the fuel cell system and generating a fuel control signal and an air control signal based on the transfer function.

2. The fuel cell control system of claim 1, further comprising a time control unit for determining a time interval for a loop operation of a system, wherein the measuring unit is prompted to measure the electrical output at the electrical output end in an end of the time interval.

3. The fuel cell control system of claim 2, wherein the time interval is 1/100 second.

4. The fuel cell control system of claim 1, wherein the electrical output end is connected to a load.

5. The fuel cell control system of claim 4, wherein the load is a DC motor.

6. The fuel cell control system of claim 1, wherein the arithmetic logic unit comprises the following equations:
$${min}_{{G}_{0}} {max}_{{G}_{i}} δ ( {G}_{0} , {G}_{i} )$$
$$and$$
$$b ( {G}_{0} , K ) = {‖ [ \begin{matrix}K \\ I\end{matrix} ] {( I - {G}_{0} K )}^{- 1} [ I {G}_{0} ] ‖}_{∞}^{- 1} \geq ɛ$$
wherein G₀ refers to a nominal plant, Gᵢ is a perturbed plant, ε denotes a maximum perturbation of the perturbed plant, K represents a designed controller, b(G₀,K) describes a stability bound of the designed controller based on the nominal plant, and ∥T∥_{∞} refers to an infinity norm of a system T.

7. The fuel cell control system of claim 1, wherein the air supply module comprises an air-feeding device and controls the air-feeding device to regulate an air supply volume.

8. The fuel cell control system of claim 1, wherein the fuel supply module comprises a solenoid valve and controls the solenoid valve to regulate a fuel supply amount.

9. The fuel cell control system of claim 1, wherein the fuel supply module comprises a hydrogen bottle and the fuel is hydrogen.

10. A fuel cell control method, comprising:
setting a default electrical output via a control module;
sending a fuel supply test signal to a fuel supply module and an air supply test signal to an air supply module via the control module such that the fuel supply module supplies fuel to a fuel cell set according to the fuel supply test signal and the air supply module supplies air to the fuel cell set according to the air supply test signal;
generating an electrical output in the fuel cell set through a reaction of the fuel with the air, and transmitting the generated electrical output at the electrical output end, wherein the generated electrical output is measured by a measuring unit to obtain a test electrical output which is further sent to an arithmetic logic unit;
comparing the test electrical output, the default electrical output, a fuel supply control signal and an air supply control signal to identify a transfer function and determine control rules;
sending the fuel supply control signal to the fuel supply module and the air supply control signal to the air supply module via the control module such that the fuel supply module supplies the fuel to the fuel cell set according to the fuel supply control signal and the air supply module supplies the air to the fuel cell set according to the air supply control signal;
generating the electrical output through the reaction of the fuel with the air in the fuel cell set, and thus presenting the electrical output at the electrical output end, as well as measuring the electrical output of the fuel cell set with a measuring unit so as to obtain an electrical output to be further sent to the arithmetic logic unit; and
comparing the electrical output and the default electrical output by using the arithmetic logic unit, so as to further perform an arithmetic operation according to the control rules to dynamically adjust the fuel supply control signal and the air supply control signal; and the process returns to the sending of the fuel supply control signal and the air supply control signal.

11. The fuel cell control method of claim 10, further comprising connecting a load to the electrical output end.

12. The fuel cell control method of claim 11, wherein the load is a DC motor.

13. The fuel cell control method of claim 10, wherein the arithmetic logic unit comprises the following equations:
$${min}_{{G}_{0}} {max}_{{G}_{i}} δ ( {G}_{0} , {G}_{i} )$$
$$and$$
$$b ( {G}_{0} , K ) = {‖ [ \begin{matrix}K \\ I\end{matrix} ] {( I - {G}_{0} K )}^{- 1} [ I {G}_{0} ] ‖}_{∞}^{- 1} \geq ɛ$$
wherein G₀ refers to a nominal plant; Gᵢ is a perturbed plant; ε represents a maximum perturbation of the perturbed plant; K denotes a designed controller; b(G₀,K) describes a stability bound of the designed controller according to the nominal plant, and ∥T∥_{∞} refers to an infinity norm of a system T.

14. The fuel cell control method of claim 10, wherein the air supply module comprises an air-feeding device and controls the air-feeding device to regulate an air supply volume.

15. The fuel cell control system of claim 10, wherein the fuel supply module comprises a solenoid valve and controls the solenoid valve to regulate a fuel supply amount.

16. The fuel cell control method of claim 10, wherein the fuel supply end is a hydrogen bottle and the fuel is hydrogen.
